(19) United States
(12) Patent Application Publication
(10) Pub. No.: US 2017/0254460 A1
(43) Pub. Date: Sep. 7, 2017

(54) CONNECTION STRUCTURE FOR WATER INPUT/OUTPUT PORTS OF BOOSTER PUMP

(71) Applicant: Xiamen Runner Industrial Corporation, Xiamen (CN)

(72) Inventors: YUN-CHUAN WANG, Xiamen (CN); JING-MING LI, Xiamen (CN); JIAN-YONG YAN, Xiamen (CN)

(21) Appl. No.: 15/432,997

(22) Filed: Feb. 15, 2017

(30) Foreign Application Priority Data
Mar. 4, 2016 (CN) 201620165409.3

(51) Int. Cl. F16L 37/12; F04D 29/08; F04D 29/62; F04D 29/42

(52) U.S. Cl. CPC F16L 37/1225; F04D 29/4293; F04D 29/086; F04D 29/628

(57) ABSTRACT

A connection structure for water input/output ports of a booster pump, that is used to connect to an outside pipeline through the water input/output ports of the booster pump, comprising: a fixing tube, formed integrally with an outer shell of the booster pump, and having a window hole on a side wall of the fixing tube; an insertion tube, with one end of the insertion tube connected to an outside pipeline, with one other end of the insertion tube inserted in the fixing tube, while a fastening slot is provided on a side wall of the insertion tube; and a fastening pin, inserted into the fixing tube to act in cooperation with the fastening slot, and when the insertion tube is inserted in the fixing tube, the fastening pin fixes and restricts the position of the insertion tube.

### BACKGROUND OF THE INVENTION

Field of the Invention

The present invention relates to water transport equipment, and in particular to a connection structure for water input/output ports of a booster pump.

The Prior Arts

In general, booster pump is used quite often in raising water transport pressure to transport water in water transport pipeline. However, since water pressure is raised through mechanical means, as such, in operation, the booster pump tends to vibrate and sway, to adversely affect the tight seal of the portion connecting the booster pump and the outside pipeline. Conventionally, pipe connection is realized through threads, and the connection portion is tight sealed through using the PTFE Thread Seal Tape. Yet, for long time usage, its vibration resisting capability is insufficient, thus water leakage tends to occur when it works in a vibration prone environment.

Therefore, presently, the design and performance of the water transport equipment is not quite satisfactory, and it leaves much room for improvement.

### SUMMARY OF THE INVENTION

In view of the problems and drawbacks of the prior art, the present invention provides a connection structure for water input/output ports of a booster pump, that utilizes a pliable connection to realize better vibration resistance, while achieving easy and convenient installation.

The major objective of present invention is to provide a connection structure for water input/output ports of a booster pump, that is used to connect to an outside pipeline through the water input/output ports of the booster pump, comprising: a fixing tube, an insertion tube, and a fastening pin. The fixing tube is formed integrally with an outer shell of the booster pump, and having a window hole on a side wall of the fixing tube. The insertion tube is adapted to have its one end connected to an outside pipeline, with its other end inserted in the fixing tube, while a fastening slot is provided on a side wall of the insertion tube. The fastening pin is inserted into the fixing tube, to act in cooperation with the fastening slot, and when the insertion tube is inserted and installed in the fixing tube, the fastening pin fixes and restricts the position of the insertion tube.

In an aspect of the present invention, the connection structure further includes a fast connection structure, disposed at one end of the insertion tube connecting to the outside pipeline.

In another aspect of the present invention, the insertion tube is of an L shape or a [symbol] shape.

In yet another aspect of the present invention, the fastening pin is a U shape fastening pin, a top portion of the U shape pin is a fixing arc ring, while two sides of the U shape pin are inserting pins respectively.

In a further aspect of the present invention, an arc of the fixing arc ring is a semicircle arc, the fastening slot on a wall of the insertion tube is a ring shape fastening slot.

In another aspect of the present invention, when inserting the fastening pin into the insertion tube to fix and restrict the position of the insertion tube, the U shape fastening pin is inserted into the window hole, with a lower portion of the fixing arc ring and the insertion pins being fastened into the fastening slot on a side wall of the insertion tube, while an upper portion of the fixing arc ring is inserted into the window hole on a side wall of the fixing tube, as such achieving fixing and position restricting of the insertion tube.

In a further aspect of the present invention, the connection structure further includes a plurality of elastic tight seal rings, used to sleeved on the insertion tube, while a plurality of ring shape slots are provided on the side wall of the insertion tube, to receive the elastic tight seal rings, such that when inserting and installing the insertion tube in the fixing tube, the elastic tight seal rings sleeved around the side wall of the insertion tube are formed into interference fit with the side wall inside the fixing tube.

In the present invention, when inserting and installing the insertion tube in the fixing tube, the elastic tight seal rings sleeved around the side wall of the insertion tube are formed into interference fit with the side wall inside the fixing tube. The U shape fastening pin is inserted into the window hole, with a lower portion of the fixing arc ring and the insertion pins being fastened into the fastening slot on a side wall of the insertion tube, while an upper portion of the fixing arc ring is inserted into the window hole on a side wall of the fixing tube, as such achieving fixing and position restricting of the insertion tube axially. In such a connection structure, elastic tight seal rings are disposed between the insertion tube and the fixing tube, to provide better buffering and vibration resisting capability. The insertion tube utilizes the fixing arc ring of the U shape fastening pin to realize axial fixing. The force is exerted in an axial direction of the insertion tube, so that the connection structure will not be detached axially due to the vibration or rotation of the insertion tube. In this connection structure, threaded structure is not required, and there is no need to wind the PTFE Thread Seal Tape around, while its connection reliability is not liable to be affected by the vibration and sway of the booster pump.

In the present invention, the arc of the fixing arc ring is a semicircle arc, the fastening slot on a wall of the insertion tube is a ring shape fastening slot; while the insertion tube is an L shape tube. In such a connection structure, the insertion tube is still able to rotate, after it being fixed by the U shape fastening pin. As such, a user may adjust the water output port in a range of 360 degrees, to achieve convenience in application.

In the present invention, a fast connection structure is disposed at one end of the insertion tube connecting to the outside pipeline, such that the connection structure can be attached and detached from the outside pipeline speedily.

Further scope of the applicability of the present invention will become apparent from the detailed descriptions given hereinafter. However, it should be understood that the detailed descriptions and specific examples, while indicating preferred embodiments of the present invention, are given by way of illustration only, since various changes and modifications within the spirit and scope of the present invention will become apparent to those skilled in the art from this detailed descriptions.

### BRIEF DESCRIPTION OF THE DRAWINGS

The related drawings in connection with the detailed descriptions of the present invention to be made later are described briefly as follows, in which:

FIG. 1 is a schematic diagram of a connection structure for water input/output ports of a booster pump according to an embodiment of the present invention;

FIG. 2 is a cross section view of a connection structure for water input/output ports of a booster pump according to an embodiment of the present invention;

FIG. 3 is a schematic diagram of an L shape insertion tube according to an embodiment of the present invention;

FIG. 4 is a schematic diagram of U shape fastening pin according to an embodiment of the present invention; and

FIG. 5 is a schematic diagram of U shape fastening pin viewed from another angle according to an embodiment of the present invention.

### DETAILED DESCRIPTION OF THE PREFERRED EMBODIMENT

The purpose, construction, features, functions and advantages of the present invention can be appreciated and understood more thoroughly through the following detailed descriptions with reference to the attached drawings.

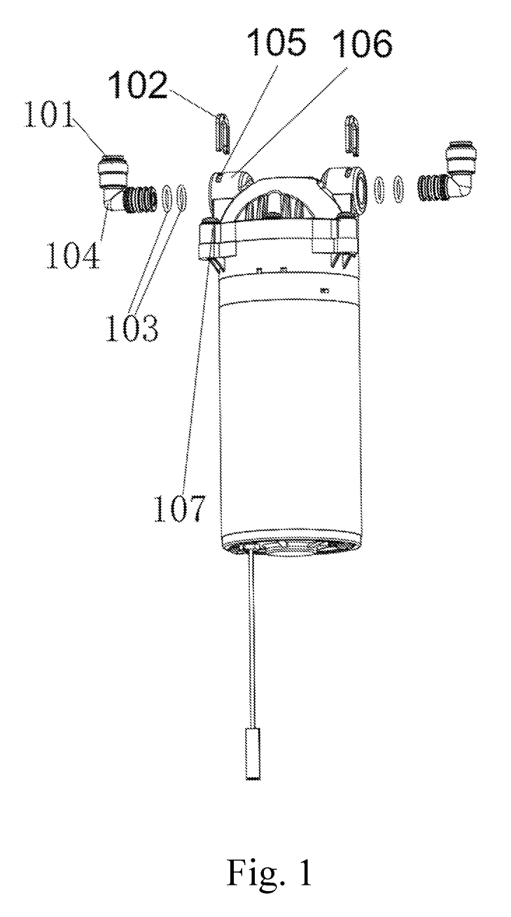

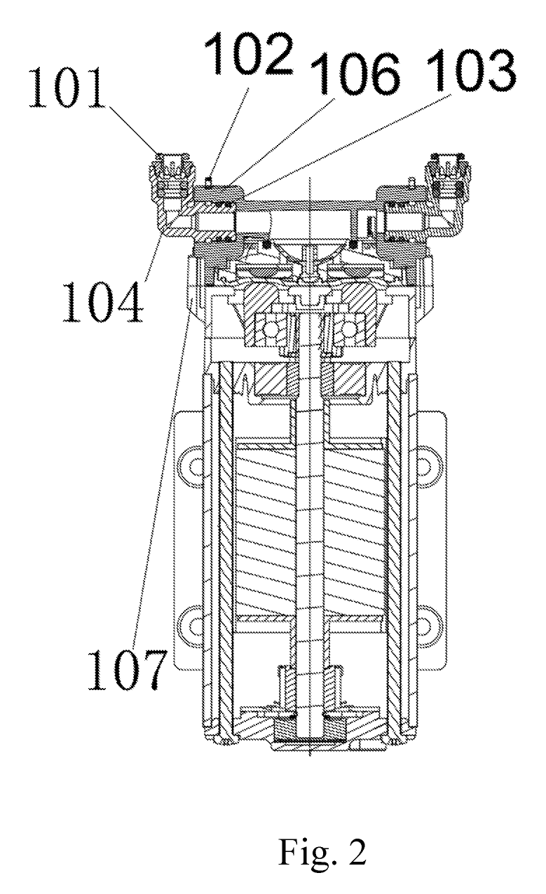

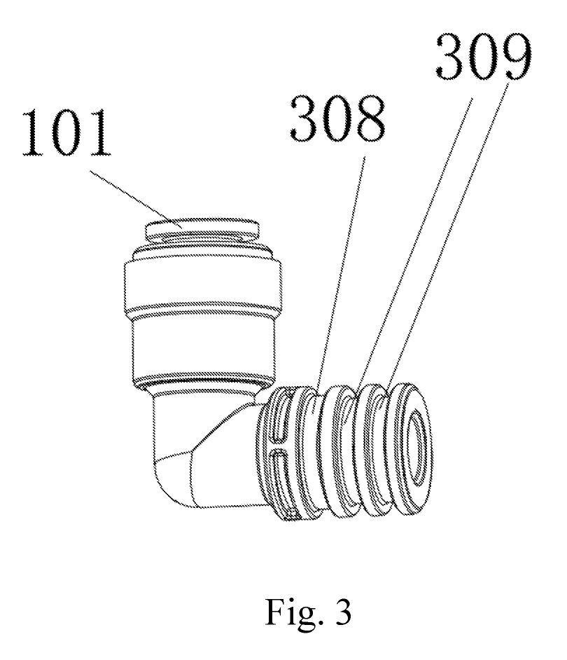

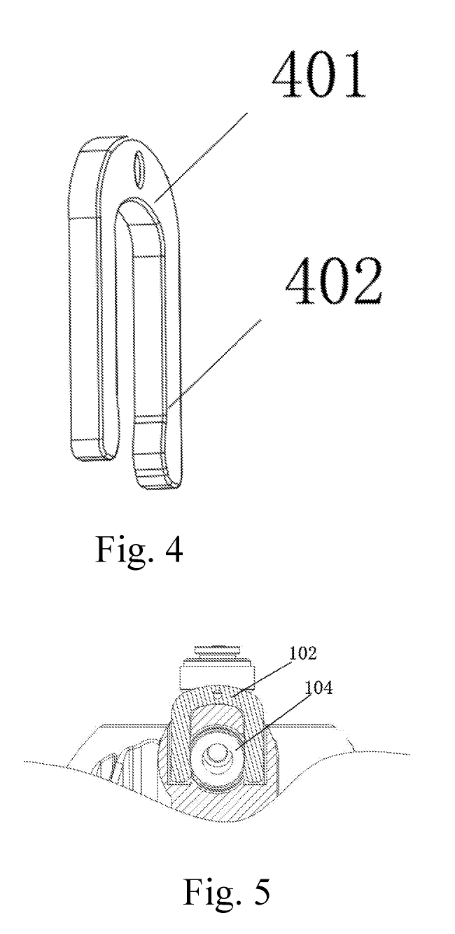

Refer to FIGS. 1 to 5 respectively for a schematic diagram of a connection structure for water input/output ports of a booster pump according to an embodiment of the present invention; a cross section view of a connection structure for water input/output ports of a booster pump according to an embodiment of the present invention; a schematic diagram of an L shape insertion tube according to an embodiment of the present invention; a schematic diagram of U shape fastening pin according to an embodiment of the present invention; and a schematic diagram of U shape fastening pin viewed from another angle according to an embodiment of the present invention.

As shown in FIGS. 1 to 5, the present invention provides a connection structure for water input/output ports of a booster pump, that is used to connect to an outside pipeline through the water input/output ports of the booster pump, comprising: a fixing tube 106, an insertion tube 104, and a fastening pin 10. The fixing tube 106 is formed integrally with an outer shell of the booster pump, and having a window hole 105 on a side wall of the fixing tube 106. The insertion tube 104 is adapted to have its one end connected to an outside pipeline, with its other end inserted in the fixing tube 106, while a fastening slot 308 is provided on a side wall of the insertion tube 104. The fastening pin 102 is inserted into the fixing tube 106, to act in cooperation with the fastening slot 308, and when the insertion tube 104 is inserted and installed in the fixing tube 106, the fastening pin 102 fixes and restricts the position of the insertion tube 104.

In an embodiment of the present invention, the connection structure further includes a fast connection structure 101, disposed at one end of the insertion tube 104 connecting to the outside pipeline.

In an embodiment of the present invention, the insertion tube 104 is of an L shape or a [symbol] shape.

In an embodiment of the present invention, the fastening pin 102 is a U shape fastening pin, a top portion of the U shape pin is a fixing arc ring 401, while two sides of the U shape pin are inserting pins 402 respectively.

In an embodiment of the present invention, an arc of the fixing arc ring 401 is a semicircle arc, the fastening slot 308 on a wall of the insertion tube 104 is a ring shape fastening slot.

In an embodiment of the present invention, when inserting the fastening pin 102 into the insertion tube 104 to fix and restrict the position of the insertion tube 104, the U shape fastening pin 102 is inserted into the window hole 105, with a lower portion of the fixing arc ring 401 and the insertion pins 402 being fastened into the fastening slot 308 on a side wall of the insertion tube 104, while an upper portion of the fixing arc ring 401 is inserted into the window hole 105 on a side wall of the fixing tube 106, as such achieving fixing and position restricting of the insertion tube 104.

In an embodiment of the present invention, the connection structure further includes a plurality of elastic tight seal rings 103, used to sleeved on the insertion tube 104, while a plurality of ring shape slots 309 are provided on the side wall of the insertion tube 104, to receive the elastic tight seal rings 103, such that when inserting and installing the insertion tube 104 in the fixing tube 106, the elastic tight seal rings 103 sleeved around the side wall of the insertion tube 104 are formed into interference fit with the side wall inside the fixing tube 106.

In an embodiment of the present invention, when inserting and installing the insertion tube 104 into the fixing tube 106, the elastic tight seal rings 103 sleeved around the side wall of the insertion tube 104 are formed into interference fit with the side wall inside the fixing tube 106. The U shape fastening pin 102 is inserted into the window hole 105, with a lower portion of the fixing arc ring 401 and the insertion pins 402 being fastened into the fastening slot 308 on a side wall of the insertion tube 104, while an upper portion of the fixing arc ring 401 is inserted into the window hole 105 on a side wall of the fixing tube 106, as such achieving fixing and position restricting of the insertion tube 104 axially. In such a connection structure, the elastic tight seal rings 103 are disposed between the insertion tube 104 and the fixing tube 106, to provide better buffering and vibration resisting capability. The insertion tube 104 utilizes the fixing arc ring 401 of the U shape fastening pin 102 to realize axial fixing. The force is exerted in an axial direction of the insertion tube 104, so that the connection structure will not be detached axially due to the vibration or rotation of the insertion tube 104. In this connection structure, threaded structure is not required, and there is no need to wind the PTFE Thread Seal Tape around, while its connection reliability is not liable to be affected by the vibration and sway of the booster pump.

In an embodiment of the present invention, the arc of the fixing arc ring 401 is a semicircle arc, the fastening slot 308 on a wall of the insertion tube 104 is a ring shape fastening slot; while the insertion tube 104 is an L shape tube. In such a connection structure, the insertion tube 104 is still able to rotate, after it being fixed by the U shape fastening pin 102. As such, a user may adjust the water output port in a range of 360 degrees, to achieve convenience in application.

In an embodiment of the present invention, a fast connection structure 101 is disposed at one end of the insertion tube 104 connecting to the outside pipeline, such that the connection structure can be attached and detached from the outside pipeline speedily.

### EMBODIMENT

The installation of the connection structure for water input/output ports of a booster pump of the present invention can be realized as follows: sleeving the elastic tight seal rings 103 into the ring shape slots 309 on the insertion tube 14, then inserting the insertion tube 14 having the elastic tight seal rings 103 sleeved on into the fixing tube 106 with force. When the fastening slot 308 of the insertion tube 104 is moved to the position of the window hole 105 of the fixing tube 106, inserting the U shape fastening pin 102 into the window hole 105, so that a lower portions of the fixing arc ring 401 and the insertion pins 402 are fastened into the fastening slot 308 on a side wall of the insertion tube 104, while an upper portion of the fixing arc ring 401 is inserted into the window hole 105 on a side wall of the fixing tube 106, to fix the insertion tube 104 and restrict its axial position. Finally, connecting the insertion tube 104 to an outside pipeline through a fast connection structure 101, to finish installation of the connection structure of the present invention.

The above detailed description of the preferred embodiment is intended to describe more clearly the characteristics and spirit of the present invention. However, the preferred embodiments disclosed above are not intended to be any restrictions to the scope of the present invention. Conversely, its purpose is to include the various changes and equivalent arrangements which are within the scope of the appended claims.

What is claimed is:

1. A connection structure for water input/output ports of a booster pump, that is used to connect to an outside pipeline through the water input/output ports of the booster pump, comprising:
a fixing tube, formed integrally with an outer shell of the booster pump, and having a window hole on a side wall of the fixing tube;
an insertion tube, with one end of the insertion tube connected to the outside pipeline, with one other end of the insertion tube inserted in the fixing tube, while a fastening slot is provided on a side wall of the insertion tube; and
a fastening pin, inserted into the fixing tube, to act in cooperation with the fastening slot, and when the insertion tube is inserted and installed in the fixing tube, the fastening pin fixes and restricts a position of the insertion tube.

2. The connection structure for water input/output ports of a booster pump, that is used to connect to an outside pipeline through the water input/output ports of the booster pump as claimed in claim 1, further comprising:
a fast connection structure, disposed at one end of the insertion tube connecting to the outside pipeline.

3. The connection structure for water input/output ports of a booster pump, that is used to connect to an outside pipeline through the water input/output ports of the booster pump as claimed in claim 1, wherein the insertion tube is of an L shape or an [symbol] shape.

4. The connection structure for water input/output ports of a booster pump, that is used to connect to an outside pipeline through the water input/output ports of the booster pump as claimed in claim 1, wherein the fastening pin is a U shape fastening pin, a top portion of the U shape pin is a fixing arc ring, while two sides of the U shape pin are inserting pins respectively.

5. The connection structure for water input/output ports of a booster pump, that is used to connect to an outside pipeline through the water input/output ports of the booster pump as claimed in claim 4, wherein an arc of the fixing arc ring is a semicircle arc, the fastening slot on a wall of the insertion tube is a ring shape fastening slot.

6. The connection structure for water input/output ports of a booster pump, that is used to connect to an outside pipeline through the water input/output ports of the booster pump as claimed in claim 5, wherein when inserting the fastening pin into the insertion tube to fix and restrict the position of the insertion tube, the U shape fastening pin is inserted into the window hole, with a lower portion of the fixing arc ring and the insertion pins being fastened into the fastening slot on a side wall of the insertion tube, while an upper portion of the fixing arc ring is inserted into the window hole on a side wall of the fixing tube, as such achieving fixing and position restricting of the insertion tube.

7. The connection structure for water input/output ports of a booster pump, that is used to connect to an outside pipeline through the water input/output ports of the booster pump as claimed in claim 1, further comprising:
a plurality of elastic tight seal rings, used to sleeved on the insertion tube, while a plurality of ring shape slots are provided on the side wall of the insertion tube, to receive the elastic tight seal rings, such that when inserting and installing the insertion tube in the fixing tube, the elastic tight seal rings sleeved around the side wall of the insertion tube are formed into interference fit with the side wall inside the fixing tube.
